(19) United States
(12) Patent Application Publication
(10) Pub. No.: US 2004/0165529 A1
(43) Pub. Date: Aug. 26, 2004

(54) Overload control method of high speed data communication system

(75) Inventor: Jong-Kyu Lee, Anyang (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/626,557

(22) Filed: Jul. 25, 2003

(30) Foreign Application Priority Data
Jul. 26, 2002 (KR) 44110/2002

(51) Int. Cl. H04L 12/26

(52) U.S. Cl. 370/230; 455/512

(57) ABSTRACT

An overload control method of a high speed data communication system can include judging whether an access network is overloaded, determining a class of the overload and restricting an originating call and a termination call according to the determined class during the overload. Since the access terminal, which can be the lowermost terminal of the system, controls the data call origination, resources at the side of the access network can be effectively managed. In addition, the overload control can be discriminately performed according to a degree of the overload so that the overload control method can effectively cope with the overload situation.

### BACKGROUND OF THE INVENTION

1. Field of the Invention

The present invention relates to a data communication system and method and, more particularly, to an overload control apparatus and method of a high speed data communication system.

2. Background of the Related Art

1xEV-DO (Evolution-Data Only), a high speed data service dedicated system, is a protocol for a packet data transmission different from the IS-2000 radio protocol. In case of the forward channel of 1xEV-DO, up to 2.457 Mbps can be transmitted.

1xEV has been developed by Qualcomm from an experience that led to success of commercialization of cdmaOne and cdma2000 technology, which was called HDR (High Data Rate). At present, a CDMA Development Group is developing it as a counter-technology of the IMT-2000 (asynchronous).

1xEV-DO has an asymmetric data rate structure with a forward channel rate of maximum 2.457 Mbps and a backward channel rate of 153.6 Kbps. That is, the forward channel rate and the backward channel rate are different because an environment of an access terminal is bad compared to an access network and a download service (e.g., the Internet) is superior to an upload service.

FIG. 1 is a diagram that illustrates a construction of a related art high data communication system. As shown in FIG. 1, the 1xEV-DO system includes an access terminal (AT) 101, an access network (AN) 102, a packet control function (PCF) 103, a packet data serving node (PDSN) 104 and an authentication server (AN-AAA: Access Network-Authentication, Authorization, Accounting) 105.

The access network 102 collectively refers to the BTS (or ANTS (Access Network Transceiver System)) and a BSC (or ANC (Access Network Controller)) of the existing 2G system. An Interface (radio section) between the access terminal 101 and the access network 102 follows C.S0024 (version 3.0) standard of 3GPP2.

The PDSN 104 performs an interfacing function to provide a packet data service (e.g., Internet access service) to the access terminal 101. The authentication server (AN-AAA) performs an authentication on a 1xEV-DO subscriber and interfaces with the PCF 103. The interface between the PCF 103 and the authentication server follows TIA/EIA/IS-878.

FIG. 2 is a diagram that shows general 1x EV-DO forward channels. As shown in FIG. 2, the forward channel from the access network (AN) to the access terminal 101 consists of a pilot channel, a medium access control (MAC) channel, a traffic channel and a control channel. The pilot channel is used as a ‘basic signal’ for obtaining a system. The traffic channel and the control channel are used for transmitting data and control information for call processing control. The MAC channel is mainly used to control a transfer rate, having a reverse activity channel, a DRC lock channel and a reverse power control channel.

The reverse activity channel relates to a quantity of a reverse traffic and informs the access terminal 101 of whether the backward traffic channel is congested. The reverse power control channel controls delivery power of the backward link of the access terminal 101. The DRC lock channel is used to inform the access terminal 101 of whether the access network 102 should decode a DRC coming from the access terminal 101 or not.

The signal transmission system in the forward channel corresponds logically to time-division and physically to signal spread, which is called a TD-CDMA (Time Division-Code Division Multiple Access).

FIG. 3 is a flow chart that shows a related art originating call set-up procedure of a high speed data communication system. FIG. 4 is a flow chart of a related art originating call set-up procedure with a session. Because 1xEV-DO system is a data processing dedicated system, a call processing flow differs according to whether session information on a packet data is in a PCF data base (refer to FIG. 4) or not (refer to FIG. 3).

With reference to FIG. 3, usually when a general terminal is power-on, a session is automatically established. A new session establishment of FIG. 3 will be described.

The access terminal 101 transfers a message requesting assignment of a unicast access terminal identifier (UATI) (UATI-request) to the access network 102 (step S101). Then, the access network 102 transfers a UATI assignment message to the access terminal 101.

Upon receiving the UATI-assignment message, the access terminal 101 transfers a message informing receipt of the UATI-assignment (UATI-complete) to the access network 102 (step S103). Steps S101 and S102 describe an address managing protocol, and the UATI is a terminal address temporarily assigned when the access terminal 101 attempts connection to a system. Thereafter, in a connection establishment procedure (step S104), the access terminal 101 requests the access network 102 to assign a forward traffic channel, a reverse power control channel and a backward traffic channel required to communication with the access network 102, and receives the requested channels.

Since there is no session established between the access terminal 101 and the access network 102, the access terminal 101 performs a session establishment procedure with the access network 102 in order to establish a new session (step S105).

When the access terminal 101 transfers a message (XonRequest) requesting transition to an open state (access stream) (step S106), the access network transfers a message (XonResponse) in response to the message (XonRequest) (step S107). When a session establishment procedure is completed, the access terminal 101 performs a point-to-point protocol (PPP) and an LCP (Link Control Protocol) procedure to perform an authentication (step S108).

The access network 102 generates a challenge handshake authentication protocol (CHAP) challenge packet defined in RFC1994 and transfers it to the access terminal 101 (step S109). When the access network 102 receives a response message (CHAP response packet) from the access terminal 101, the access network 102 transfers a RADIUS access request message to the authentication server (AN-AAA) (step S110).

Upon receiving the RADIUS access request message, the authentication server (AN-AAA) performs an authentication procedure. If the authentication is successful, the authentication server transfers an access accept message to the access network 102 (step S111). At this time, the access accept message includes 15-dibit MN ID.

The access network 102 informs the access terminal 101 that the CHAP authentication has been successful (step S112), and the access terminal 101 transfers a message requesting transition to an open state (service stream) to the access network 102 (step S113). Then, the access network 102 transfers a message (XonResponse) in response to the message (XonRequest) (step S114).

When the steps S101˜S114 are successfully completed, the access network 102 transfers a message for A8 connection set-up (A9-Setup-A8) to the PCF 103 and drives a timer (T_{A8-Setup}) (step S115).

Upon receiving A9-setup-A8, the PCF 103 performs an A10/A11 connection establishment procedure with the PDSN 104, sets up A8 connection and transfers a certain message (A9-Connect-A8) to the access network 102 (step S117). Upon receiving the A9-Connect-A8 message, the access network 102 terminates the timer T_{A8-Setup}.

A9 is a signaling channel between the access network 102 and the PCF 103. A10 is a traffic channel between the PCF 103 and the PDSN 104. A11 is a signaling channel between the PCF 103 and the PDSN 104.

When the A10/A11 connection establishment procedure (S116) is completed, a communication path is formed between the access terminal 101 and the PDSN 104 by a point-to-point protocol connection (step S118), through which the access terminal 101 and the PDSN 104 transmits and receives packet data (step S119).

FIG. 4 is a flow chart that shows a originating call set-up procedure in case of using an existing session (reactivation in a dormant state). As shown in FIG. 4, if a session is previously established, 1xEV-DO system refers to session information of the PCF database, so that the steps S105˜S114, the step S116 and the step S118 are not performed.

That is, when the connection establishment procedure (step S104) is completed, the access network 102 transfers the message for setting up A8 connection (A9-Setup-A8) to the PCF 103 and drives the timer T_{A8-Setup} (step S115).

Upon receiving the A9-Setup-A8, the PCF 103 sets up A8 connection and transfers a certain message (A9-Connect-A8) to the access network 102 (step S117). Upon receiving the A9-Connect-A8 message, the access network 102 terminates the timer T_{A8-Setup}. Through the pre-established communication path, the access terminal 101 and the PDSN 104 transmits and receives packet data (step S119).

As described above, the related art has various disadvantages. For example, in the related art, when the access network is overloaded, the overload is controlled by simply rejecting a call originating message (e.g., call connection request) of a terminal, for example, the connection request (e.g., or channel assignment request) message in the connection establishment procedure (step S104).

However, in case of applying the related art overload control method to the 1xEV-DO system, the session is necessarily connected to transmit traffic data. Without the session connection, a terminal, of which call connection request has been rejected due to overload, keeps transferring the message to the corresponding access network until the call connection request is accepted, resulting in that the load of the access network becomes heavier.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide an overload control method of a data communication system that discriminately restricts an originating call and a termination call according to class of overload.

Another object of the present invention is to provide an overload control method of a data communication system that restricts at least an originating call according to an overload status.

Another object of the present invention is to provide an overload control method of a data communication system that restricts at least an originating call according to an overload status at an access terminal level.

To achieve at least the above objects in whole or in part, there is provided a method that includes judging whether an access network is overloaded and determining a class of the overload for restricting an originating call and a termination call according to the determined class.

A restriction of the originating call can be performed by an access terminal according to an instruction of a base station processor of the access network.

Preferably, restricting an originating call can include loading APersistence value according to the determined class from a database, carrying the APersistence value on an access parameter and transferring it to an access terminal, obtaining a persistence probability value with reference to the received APersistence value and generating a normalized random number and comparing the random number with the persistence probability value, attempting a call originating if the random number is smaller than the persistence probability value, and attempting a call originating according to an access channel cycle if the random number is greater than or the same as the persistence probability value.

To further achieve at least the above objects in a whole or in part, there is provided a method that includes checking a load state of an access network, determining a class of overload when the access network is overloaded and loading a call acceptance rate according to the determined class from a database, and restricting an originating call and a termination call with reference to the call acceptance rate.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram that illustrates a construction of a related art high speed data communication system;

FIG. 2 is a diagram that shows 1xEV-DO forward channels;

FIG. 3 is a flow chart that shows an originating call set-up procedure of a high speed data communication system in accordance with a related art;

FIG. 4 is a flow chart that shows an originating call set-up procedure with a session in accordance with the related art;

FIG. 5A is a flow chart that shows judging an overload of an access network according to a preferred embodiment;

FIG. 5B is a flow chart that shows releasing overload judgment of the access network according to a preferred embodiment;

FIG. 6 is a table showing an exemplary acceptance rate according to an overload control level;

FIG. 7 shows an exemplary message structure of access parameters; and

FIG. 8 is a table showing exemplary APersistence field values and persistence probability corresponding to overload control levels.

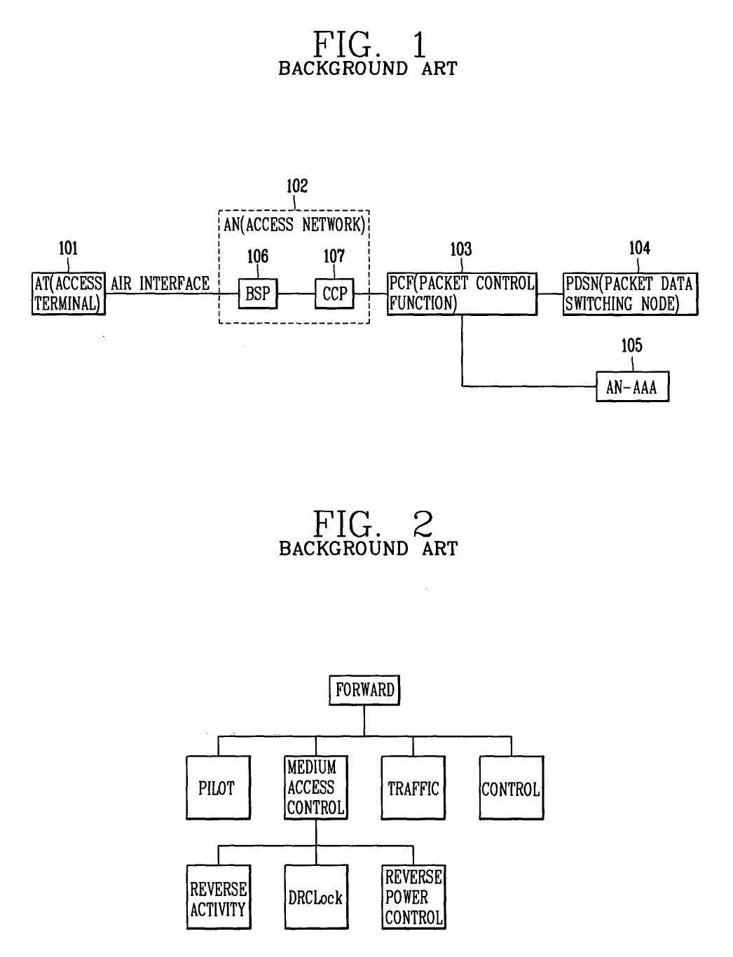

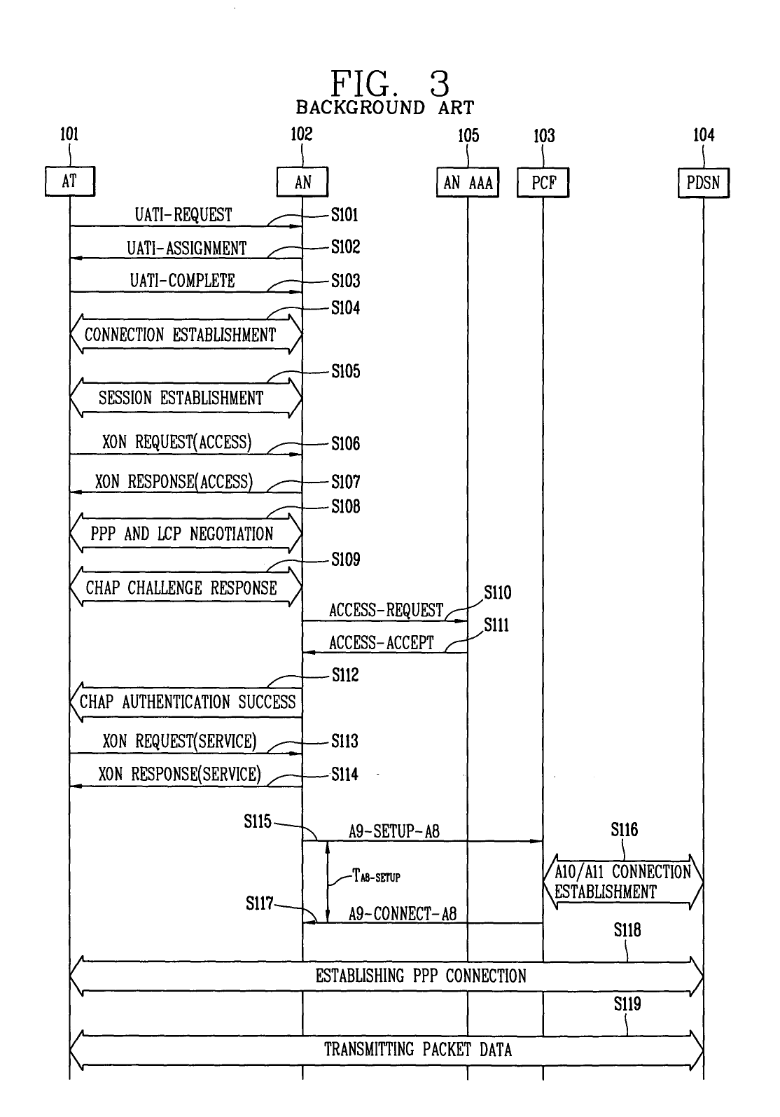

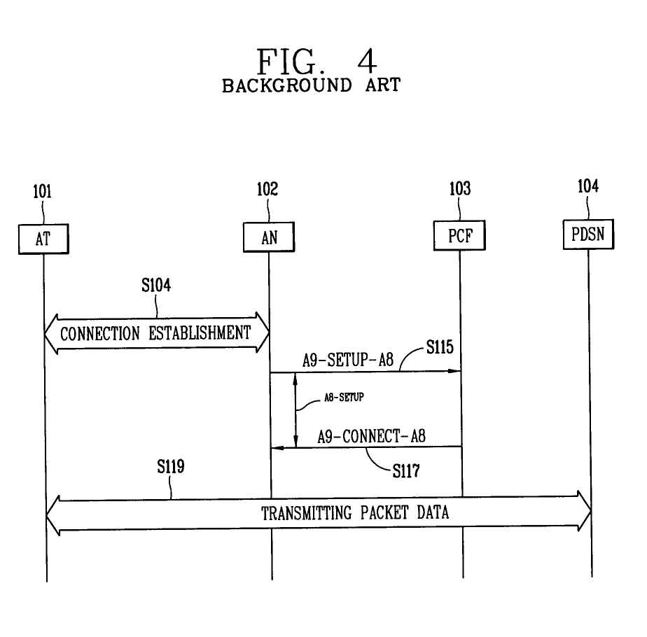

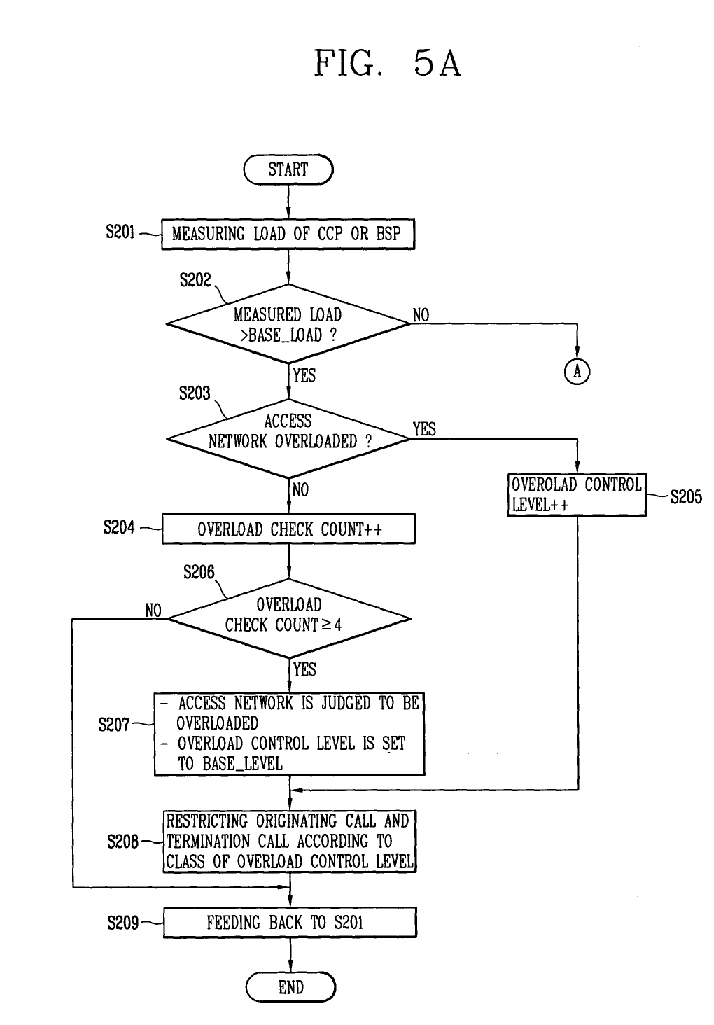

### DETAILED DESCRIPTION OF PREFERRED EMBODIMENTS

An access network, collectively referring to a BTS (or ANTS) and a BSC (or ANC), can include main processors called a base station processor (BSP) 106 and a call control processor (CCP) 107. Preferred embodiments according to the present invention can be implemented such that an overload control process periodically checks whether the access network is overloaded, and when the access network is overloaded, a call is discriminately restricted according to a degree of overload.

An overload control process or apparatus can classify, for example, 24 classes of overload according to the overload degree and restrict at least one of an originating call and a termination call processed on the basis of each class. The overload control process can periodically (e.g., 2 seconds) measure a processor occupancy rate and update an overload control level (L) of the access network. The processor occupancy rate preferably signifies a rate assumed by the call processing operation from the overall operation of the call control processor (or base station processor).

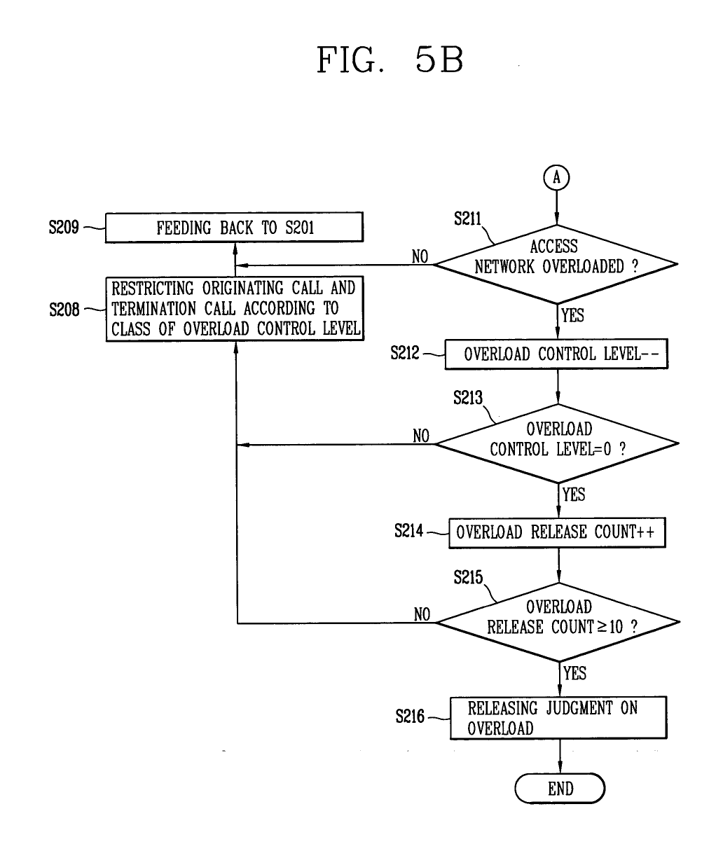

Preferred embodiments according to the present invention will now be described with reference to the accompanying drawings. FIG. 5A is a flow chart that shows a method of judging an overload of an access network, and FIG. 5B is a flow chart that shows a method of releasing the judgment on the overload of the access network.

A controller like the CCP 107 can be periodically (e.g., 2 seconds) measure a processor occupancy rate (e.g., CCP, BSP or the like) (step S201), and if the measured processor occupancy rate is continuously maintained for a prescribed time (e.g., 8 seconds) above a reference value (e.g., 70%), the CCP judges that an access network to which the CCP itself belongs is in an overload state (steps S202˜S207). At this time, an overload control level of the access network is preferably set to 12 (e.g., Base_Level) (step S207). Preferably, to release the overload judgment for the access network, a lowest overload control level (e.g., class ‘0’) should be continuously maintained for a selected time like 20 seconds (e.g., consecutively measured by 10 times at the period of 2 seconds) (steps S213˜S215).

A preferred embodiment of a judgment on overload and release of the judgment on overload will now be described. As shown in FIG. 5A, after a process starts, the CCP 107 or the BSP 106 measures the processor occupancy rate periodically (e.g., by a prescribed unit such as 2 seconds) (step S201) and stores the processor occupancy rate in a load value storing device or database. There can be 10 load value storing databases or the like, which are referred to when the CCP 107 or the BSP 106 judges overload or releases the overload judgment. As the measured load values are stored in the database, the overload judging process (steps S202˜S206) are performed.

An exemplary condition for judging an overload state of the access network is that a measured processor occupancy rate is above a prescribed amount (e.g. above 70%), which is maintained for more than a prescribed time such as 8 seconds.

If the access network is judged to be overloaded, the CCP 107 or the BSP 106 can update an overload detection flag database and a control level (L) database. At this time, the overload control level set for the access network is preferably set to a Base_Level (e.g., level 12). However, the present invention is not intended to be so limited. For example, an operator may arbitrarily set a default value of the Base_Level according to a system environment.

Once the access network is judged to be overloaded, the overload control level is re-evaluated through the periodically performed steps S201 and S202. That is, if a measured load value of the CCP 107 or the BSP 106 is greater than the reference value (or the base-load), the CCP 107 or the BSP 106 preferably grades up or increases the overload control level by one step or a prescribed number of steps (step S205). If, however, a measured load value of the CCP 107 or the BSP 106 is smaller than or the same as the reference value, the CCP 107 or the BSP 106 preferably grades down or decreases the overload control level by one step or a prescribed number of steps (step S212).

At this time, the base-load has a tolerance margin of about 2%. In addition, the CCP (or BSP) preferably restricts an originating call and a termination call according to a corresponding overload control level by referring to the overload detection flag database and the control level (L) database (step S208).

Thereafter, when the overload control level becomes ‘0’ as the load of the CCP 107 or the BSP 106 is gradually reduced, the access network is preferably released from the judgment on its overload state at the point when the overload control level ‘0’ is continued for a prescribed time (e.g., 20 seconds) (steps S213˜S216).

Call restriction information (or call acceptance information) by overload control levels can be stored in a separate database. When the access network is overloaded, the CCP (or BSP) refers to the call restriction information by the overload control levels from the corresponding database.

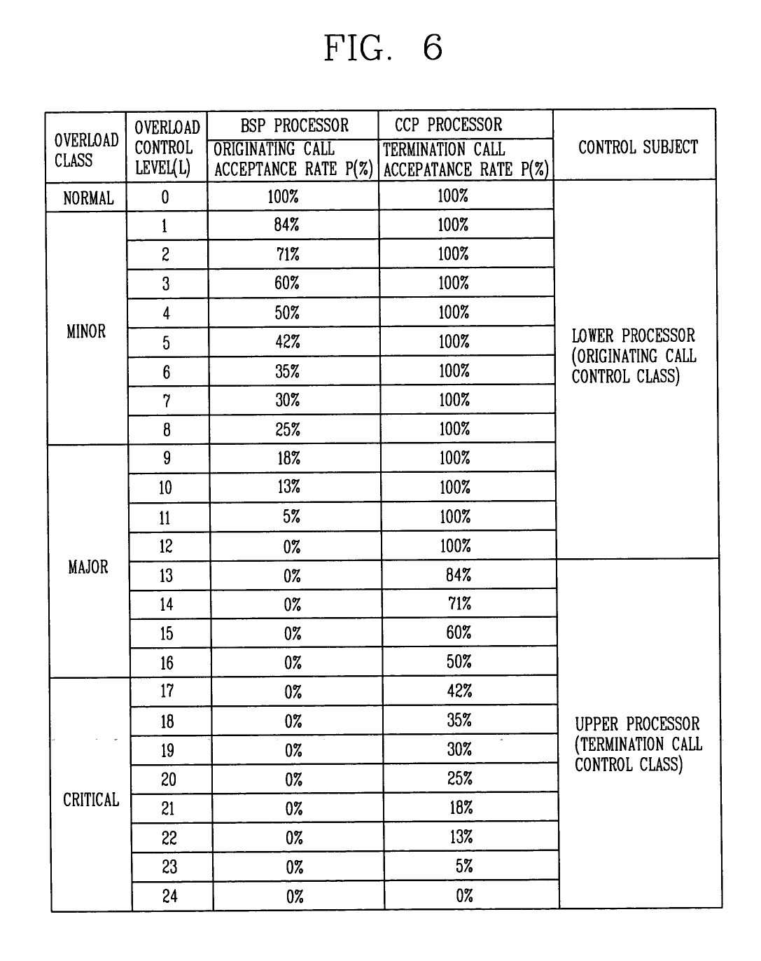

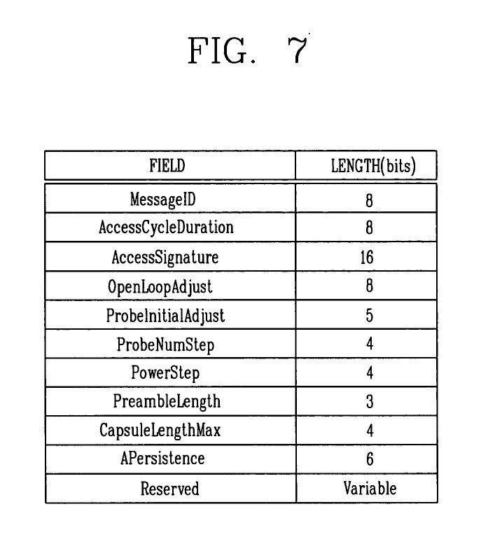

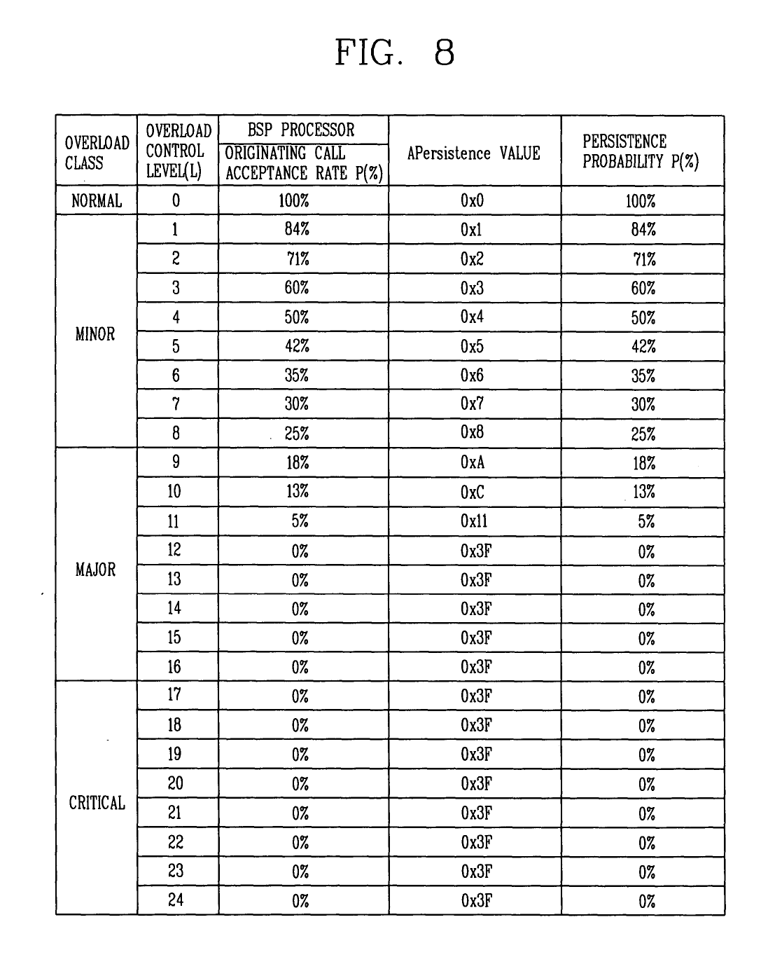

When the access network is judged to be overloaded, the CCP 107 can inform the BSP 106 accordingly. Then, the BSP 106 preferably carries an APersistence value (see FIG. 8) according to the overload control level class of the access network on an APersistence Field (see FIG. 7) of an access parameter message and transmits it to the access terminal 101. Upon receiving the access parameter message, the access terminal 101 restricts an originating call by referring to the APersistence field value (step S208). FIG. 6 is a table showing an exemplary call acceptance rate according to an overload control level.

Overload control operations according to preferred embodiments of the present invention will now be described with reference to FIGS. 5A, 5B and 6.

A. Overload Control Level (L):

When the access network is judged to be overloaded, the CCP 107 periodically measures a processor occupancy rate and re-evaluates the overload control level (L). In order to release the overload state of the access network, the CCP 107 preferably restricts an originating call (e.g., a call connected from the access terminal) or a termination call (e.g., a call connected from an upper system of the access network).

If the control level (L) is smaller than the base level (e.g., 12), the access terminal 101 can restrict an originating call according to an instruction of the BSP 106. If, however, the control level (L) is greater than or the same as the base level (e.g., 12), preferably the access terminal 101 would not perform a call originating any longer according to the instruction of the BSP 106, while the CCP 107 restricts a termination call.

In this manner, according to preferred embodiments of the present invention, the overload control method and apparatus can divide the overload control level into an originating call restriction part (base level>L) and an originating call/termination call restriction part (base level≦L), so that the processors (e.g., BSP and CCP) can flexibly cope with the overload according to the degree of overload and interwork with each other.

B. Overload Control Level (L) Determination

Once the access network is judged to be overloaded, the CCP 107 can periodically measure a processor occupancy rate (p) and reset a class of the control level (L) on the basis of the measurement result. An overload control level is preferably determined by the below equation (1).

If a processor occupancy rate measured in a control section is greater than ‘base load (γ)±α’, the control level is graded up by one step. If a processor occupancy rate measured in a control section is in the range of ‘base load (γ)±α’, the current class is maintained. Otherwise, the control level is graded down by one step.

$$L = \{ \begin{matrix}min [ m , L + 1 ] \\ max [ m , L - 1 ] \\ current grade maintained\end{matrix} \begin{matrix}if ρ > 0.7 \pm α \\ otherwise \\ 0.7 - α \leq ρ \leq 0.7 + α\end{matrix} \qquad ( 1 )$$

wherein ‘m’ is the highest control level (e.g., 24), α is a value making a reference value of the processor occupancy rate (y, e.g., 70%) be in a predetermined range (70%−α≦ρ≦70%+α), in order to prevent the overload control level from being changed frequently due to a fine change of the processor occupancy rate. For example, α can be about 2%.

C. Originating Call Restriction

FIG. 7 is a diagram that shows an exemplary message structure of access parameters. As shown in FIG. 7, the message structure can be defined on pages 8˜31 of 3GPP2 C.S0024 Ver.3.0 (Version up standard for IS-856), which is hereby incorporated by reference in its entirety.

The access network 102 preferably periodically transfers access parameters to the access terminal 101 through the control channel (e.g., 256 chips=256×1.666 ms=426.7 ms, 1xEV-DO system standard). When the access network is judged to be overloaded, the BSP 106 can control call originating of the access terminal 101 by using a certain field, here the APersistence field value of a certain message (e.g., access parameters).

In other words, when the access network is judged to be overloaded and a control level of the overload is determined, the BSP 106 loads an APersistence value (n) according to the determined control level from the database. Then, the BSP 106 carries the APersistence value on the access parameter and transfers the APersistance value to the access terminal 101.

Upon receiving the access parameter message from the access network 102, the access terminal 101 extracts the APersistence value (n) from the APersistence field and uses the extracted Apersistence value (n) to preferably obtain a persistence probability. For example, the access terminal 10 can substitute the extracted APersistence value (n) into equation (2) to obtain a persistence probability (p). Then, the access terminal 101 can perform a persistence testing on the basis of the persistence probability (p). A use of the APersistence field defined in standard is an access persistence vector. In accordance with a preferred embodiment, the APersistence value is a type of parameter for obtaining an originating call acceptance rate, so that an originating call acceptance rate can be obtained by substituting the APersistence value (n) to below equation (2). The persistence probability (p) and the originating call acceptance rate are preferably identical to each other.

p=2^{-(n/4)} (2)

The persistence test can be used to generate a uniformly distributed random number x over a prescribed range e.g., (0<x<1), and compare the persistence probability value p and ‘x’. If comparison result is x<p, the persistence test has a result value of ‘success’. If x≧p, the persistence test has a result value of ‘failure’.

If the overload control level (L) is smaller than the base level (e.g., 12) and the persistence test result is ‘success’, the access terminal 101 preferably normally attempts a call connected to the access network. If, however, the persistence test result is ‘failure’, the access terminal 101 preferably attempts a call connection according to an access channel cycle (256 chips=256×1.666 ms=426.7 ms).

In this manner, the call connection attempt of the access terminal 101 according to the persistence test result (‘success’, or ‘failure’) depends on a probability. Thus, the probability becomes high (that is, a probability that persistence test result is ‘success’) that as the value ‘p’ increases, the randomly generated ‘x’ is smaller than ‘p’. Meanwhile, the probability becomes low (that is, the probability that persistence test result is ‘success’) that as the value ‘p’ decreases, the randomly generated ‘x’ is smaller than ‘p’.

Preferably, when the overload control level (L) is greater than or the same as the base level (e.g., 12), ‘p’ is set to ‘0’ and the access terminal does not perform a call originating any longer. When a load quantity of the processor (BSP or CCP) is normal, ‘p’ is ‘1’ and the persistence test result is always ‘success’. Therefore, the access terminal 101 normally attempts a call connection.

FIG. 8 is a table showing exemplary APersistence field values and persistence probability p corresponding to overload control levels (0˜24). As shown in FIG. 8, if the overload control level is 12˜24, the APersistence value is set to ‘0x3F’. With this value, ‘p’ is set to ‘0’, and the access terminal does not perform a call originating any longer. Further, the CCP 107 accepts only termination call as many as defined by overload control level.

If the overload control level is 1˜11, ‘p’ is preferably calculated on the basis of the APersistence value (n) and the persistence test is performed. Then, the access terminal 101 restricts originating call according to the result of the persistence test. At this time, however, the CCP 107 preferably does not restrict termination call.

As described above, preferred embodiments of an overload control method and apparatus of a high speed data communication system in accordance with the present invention have various advantages. In accordance with preferred embodiments, because the access terminal, which is the lowermost terminal of the system, can control the data call originating, and resources at the side of the access network can be effectively managed. In addition, the overload control is discriminately performed according to a degree of overload, so that the overload control method and apparatus can effectively cope with the overload situation and removal.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An overload control method of a data communication system comprising:
judging whether an access network is overloaded; and
determining a class of the overload and restricting an originating call and a termination call according to the determined class, when the access network is overloaded.

2. The method of claim 1 wherein, the determining and restricting is performed periodically until the overload judgment is released.

3. The method of claim 2, wherein the overload judgment is released when an overload class is consecutively maintained at a lowest level for more than a prescribed number of periods.

4. The method of claim 1, wherein when the determined class is lower than a base-level, only the originating call is restricted, and wherein when the determined class is higher than the base-level, the termination call and the originating call are restricted.

5. The method of claim 4, wherein when the determined class is higher than the base-level, all the originating calls and some termination calls are restricted.

6. The method of claim 4, wherein the base-level can be changed arbitrarily by an operator, and wherein the base-level is an initial value of the overload class set when an access is judged to be overloaded.

7. The method of claim 1, wherein the restriction of the originating calls is performed by an access terminal according to an instruction of a base station processor of the access network.

8. The method of claim 1, wherein the restricting the originating call comprises:
loading a prescribed value according to the determined class from a database;
carrying the prescribed value on a message parameter and transferring it to an access terminal;
obtaining a persistence probability value with reference to the received prescribed value and generating a random number; and
comparing the random number with the persistence probability value, attempting a call originating when the random number is less than the persistence probability value, and attempting a call originating according to an access channel cycle when the random number is not less than the persistence probability value.

9. The method of claim 1, wherein the overload judging comprises:
measuring a load of the access network at a predetermined interval;
comparing the measured load with a reference load; and
judging that the corresponding access network is overloaded when the measured load is greater than the reference load for a prescribed number of consecutive intervals.

10. The method of claim 9, wherein the reference load has a tolerance margin of about 2%.

11. An overload control method of a high speed data communication system comprising:
checking a load state of an access network;
determining a class of overload when the access network is overloaded and determining a call acceptance rate according to the determined class; and
restricting an originating call and a termination call in accordance with the call acceptance rate.

12. The method of claim 11, wherein when the determined class is lower than a base-level, only an originating call is restricted, and wherein when the determined class is higher than the base-level, both the termination call and the originating call are restricted.

13. The method of claim 12, wherein when all the originating calls and some termination calls are restricted the determined class is higher than the base-level.

14. The method of claim 11, wherein the checking the load state comprises:
periodically measuring a load of the access network;
comparing the measured load with a reference load; and
judging that the corresponding access network is overloaded when the measured load is greater than the reference load for a prescribed number of consecutive periods.

15. The method of claim 11, wherein the restriction of the originating call is performed by an access terminal.

16. The method of claim 11, wherein the restricting the originating call comprises:
loading a control signal value according to the determined class;
carrying the control signal value on an access parameter and transferring the control signal to an access terminal;
obtaining a persistence probability value with reference to the received control signal and generating a random number between 0 and 1; and
comparing the random number with the persistence probability value:
attempting originating calls when the random number is smaller than the persistence probability value, and attempting the originating calls according to an access channel cycle when the random number is not smaller than the persistence probability value.

17. The method of claim 16, wherein the persistence probability value (p) is obtained by the following equation:
p=2^{-(n/4)}, wherein ‘n’ is the control signal value.

18. The method of claim 17, wherein the control signal is APersistence value.

19. A data communication system, comprising:
an access network that includes a processor configured to repeatedly determine a variable load status of the access network, and wherein the processor determines a class of overload when the access network is overloaded;
an access terminal coupled to the access network configured to restrict originating calls in accordance with the overload class, wherein a call acceptance rate is judged from the overload class that restricts both originating and termination calls when the determined class is below a base-level and restricts the originating calls when the determined class is not below the base-level;
a packet control unit coupled to the access network configured to provide packet service to the access terminal; and
an authentication server coupled to the packet control unit configured to provide authentication functions to the packet control unit.
